(19) United States
(12) Patent Application Publication
(10) Pub. No.: US 2025/0284000 A1
(43) Pub. Date: Sep. 11, 2025

(54) Method for Operating a Measuring Device

(71) Applicant: Robert Bosch GmbH, Stuttgart (DE)

(72) Inventors: Andreas Frischen, Leonberg (DE); Andreas Koelsch, Peiting (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Lukas Fiederer, Balingen (DE); Uwe Troeltzsch, Roesrath (DE)

(21) Appl. No.: 19/073,864

(22) Filed: Mar. 7, 2025

(30) Foreign Application Priority Data
Mar. 11, 2024 (DE) 10 2024 202 240.3

(51) Int. Cl. G01S 13/88; G01S 7/04; G01S 7/41; G01S 13/86

(52) U.S. Cl. CPC G01S 13/888; G01S 7/04; G01S 7/417; G01S 13/86

(57) ABSTRACT

A computer-implemented method for operating a measuring device, in particular a wall diagnostic device, includes (i) receiving radar data of a radar sensor unit of the measuring device, wherein the radar data depicts a wall to be diagnosed, (ii) performing wall diagnostics by performing an analysis of the radar data and providing diagnostic results via a diagnostic module of the measuring device, (iii) providing the diagnostic results and the uncertainty values via the diagnostic module on a display unit of the measuring device, and (iv) displaying the diagnostic results and the uncertainty values in the display unit.

This application claims priority under 35 U.S.C. § 119 to application no. DE 10 2024 202 240.3, filed on Mar. 11, 2024 in Germany, the disclosure of which is incorporated herein by reference in its entirety.

The present disclosure relates to a method for operating a measuring device, in particular a wall diagnostic device.

### BACKGROUND

Diagnostic devices for diagnosing walls and detecting objects formed in the walls are known in the prior art.

It is an object of the present disclosure to provide an improved method of operating a measuring device, in particular a wall diagnostic device. It is further an object to provide an improved method for training an artificial intelligence of a measuring device.

The object is achieved by the method set forth below. Advantageous embodiments are subject-matter also set forth below.

### SUMMARY

In one aspect, a method of operating a measuring device, in particular a wall diagnostic device is provided, wherein the method comprises:
receiving radar data from a radar sensor unit of the measuring device, wherein the radar data depicts a wall to be diagnosed;
performing a wall diagnostics by performing an analysis of the radar data and providing diagnostic results via a diagnostic module of the measuring device, wherein the wall diagnostic comprises:
performing an object recognition of an object disposed in the wall using the diagnostic module, wherein the object recognition comprises an object detection and an object classification, and wherein the diagnostic results comprise at least one object position in the wall and/or an object type of the object; and
determining uncertainty values for the diagnostic results by the diagnostic module, wherein the uncertainty values for the diagnostic results describe probability values that the diagnostic results match an actual state of the wall to be diagnosed, and comprise at least one probability value for the object position and/or a probability value for the object type of the object;
providing the diagnostic results and the uncertainty values to a display unit of the measuring device using the diagnostic module; and
displaying the diagnostic results and the uncertainty values in the display unit.

This can achieve the technical advantage that an improved method for operating a measuring device, in particular a wall diagnostic device, can be provided. To this end, radar data of a radar sensor unit of the measuring device which depicts the wall to be diagnosed is first received. Based on the received radar data, wall diagnostics are performed by a diagnostic module and diagnostic results are provided.

The wall diagnostics comprises performing an object recognition of an object disposed in the wall using the diagnostic module. The object recognition comprises object detection with determination of an object position and an object classification with determination of an object type of the object. The diagnostic results provided accordingly include at least the object position and the object type of the object disposed in the wall.

Further, uncertainty values for the diagnostic results are determined during the wall diagnostics. The uncertainty values here describe probability values for the indicated object position and probability values for the indicated object type. Further, the diagnostic results, including the uncertainty values, are provided by the diagnostic module to a display unit of the measuring device and are displayed to a user in the display unit.

The method thus enables an object recognition of objects disposed in a wall to be diagnosed to be performed based solely on radar data of a radar sensor unit of the measuring device. In addition, uncertainty values for the object recognition, i.e. uncertainty values for the object position and the object type, are generated and displayed in the display unit. The uncertainty values can indicate a quality of the performed object recognition to the user. If there are high probability values for the object position or the object type, the user can assume that the object recognition is high quality, while low probability values indicate a low quality for the object recognition, respectively. In this way, the wall diagnostics performed by the measuring device can additionally be improved.

According to one embodiment, the wall diagnostics further comprises:
performing a wall type classification and determining a wall type of the wall by the diagnostic module; and/or
performing an object depth determination using the diagnostic module and determining an object depth of the object in the wall, wherein the object depth is defined as a distance of the object to a surface of the wall; and/or
performing an object extension determination and determining an object extension of the object along a predefined direction via the diagnostics module, wherein the
uncertainty values further comprise at least one probability value of the wall type and/or a probability value of the object depth and/or a probability value of the object extension of the object.

This has the technical advantage that a further improved wall diagnostics can be provided. For this purpose, the diagnostic module performs a wall type classification in the course of the wall diagnostics based on the radar data of the radar sensor unit and determines a wall type of the wall to be diagnosed. Alternatively or additionally, an object depth determination is performed and an object depth of the diagnostic module disposed in the wall is determined. The object depth describes a distance of the object to a surface of the wall. Alternatively or additionally, an object extension determination is performed based on the radar data and an object extension of the object is determined along a predefined direction.

Further, the uncertainty values comprise probability values for the wall type and/or probability values for the object depth and/or probability values for the object extension of the object. By determining the wall type and/or the object depth and/or the object type, the information provided by the wall diagnostics regarding the wall to be examined may be further increased. By taking into account the probability values and uncertainty values, the quality of the wall diagnostics may be determined and displayed in the display unit.

According to one embodiment, in the object recognition, a plurality of possible object positions and/or a plurality of possible object types of the object are determined as stand-alone diagnostic results, and/or wherein a plurality of possible wall types of the wall are determined as stand-alone diagnostic results in the wall type classification, and/or wherein a plurality of possible object depths are determined as stand-alone diagnostic results in the object depth determination and/or wherein a plurality of possible object depths of the object are determined as stand-alone diagnostic results in the object extension determination, wherein each of the plurality of diagnostic results is provided with a probability value, and wherein the plurality of diagnostic results and the plurality of probability values are displayed in the display unit.

This has the technical advantage that a further improved wall diagnostics can be provided. For this purpose, several alternatives of the determined diagnostic results, including corresponding uncertainty values, are provided in the wall diagnostics. Thus, multiple object positions, multiple object types, multiple object depths, multiple object extensions, and/or multiple wall types may be provided as results of the wall diagnostics. Corresponding uncertainty values are provided and displayed in the form of probability values for each of the plurality of object positions, plurality of object types, plurality of object depths, plurality of object extensions, and/or plurality of wall types.

The different probability values describe the certainty or uncertainty that the respective object position, the respective object type, the respective object depth, the respective object extension and/or the respective wall type corresponds to the actual object position, the actual object type, the actual object depth, the actual object extension and/or the actual wall type. The user can thus be provided with additional information from the wall diagnostics.

According to one embodiment, the method furthermore comprises:
providing a selection function, wherein at least one of the displayed diagnostic results can be selected by a user of the measuring device performing the selection function.

This has the technical advantage that the wall diagnostics can be further improved. A selection function is provided for this purpose to the user. By way of the selection function, the user can select one or more of the provided diagnostic results as the correct diagnostic result. The other diagnostic results, on the other hand, are not considered further in the wall diagnostics. For example, the user can select one of the specified wall types. For example, the user already knows the wall type of the wall to be examined. By selecting the corresponding wall type, it can be taken into account in the wall diagnostics accordingly, i.e., in the object detection. This may further improve the quality of the wall diagnostics.

According to one embodiment, the method furthermore comprises:
receiving selection commands of the selection function, wherein one of the displayed diagnostic results is selected by the user using the selection commands; and
providing feedback information to an external server unit, wherein the feedback information comprises the selection commands and the diagnostic results selected there along with the respective radar data.

This may achieve the technical advantage that the wall diagnostics can be improved by the provision of feedback information. For this purpose, when the selection function is activated by the user, the corresponding selections are registered and provided as feedback information to an external server unit. Based on the feedback information provided, the diagnostic module may be improved, for example, by re-training the diagnostic module. The correspondingly improved, i.e., newly trained diagnostic module can be installed on the measuring device in the form of an update in order to thus enable improved wall diagnostics.

The feedback information provided to the external server unit comprises the radar data on which the wall diagnostics were originally performed, the diagnostic results provided, and the diagnostic results selected by actuation of the selection function by the user. Based on this, the quality of the originally performed wall diagnostics may be determined by the external server unit. Based on this, the wall diagnostics, i.e. the diagnostic module, can be improved by re-training via the external server unit.

In the sense of the application, feedback information comprises any information that is based on an action taken by the user and that can be interpreted as feedback on the quality of the performed wall diagnostics. The feedback information can be direct, if necessary text-based feedback from the user. Alternatively or additionally,

According to one embodiment, the measuring device further comprises at least one of an induction sensor and/or an eddy current sensor and/or a capacitance sensor and/or an AC current sensor and/or an NMR sensor and/or an ultrasonic sensor for providing additional sensor data, wherein the diagnostic module is configured to perform the wall diagnostics by taking into account the additional sensor data.

The technical advantage can thereby be achieved that, through further sensor data, additional sensors, each of which is configured to detect different physical variables, can provide additional information in addition to the radar data of the radar sensor unit, for incorporation into the wall diagnostics. This additional information, which is preferably complementary to the information of the radar data of the radar sensor unit, allows further precise specification of the wall diagnostics or the object recognition.

According to one embodiment, the diagnostic module comprises at least one correspondingly trained artificial intelligence configured to perform an object recognition and/or wall classification and/or object depth determination based on the radar data and/or the additional sensor data

This may achieve the technical advantage that, because the diagnostic module is formed as a correspondingly trained artificial intelligence, that is trained based on the radar data, or, if applicable, taking into account the information of the additional sensors, to perform an object recognition and/or a wall classification and/or an object depth determination and/or an object extension determination, a reliable and powerful diagnostic module can be provided. By using the artificial intelligence technique, precise wall diagnostics can be provided.

According to one embodiment, the object classes of the object type of the object comprise: metal/non-metal object, low voltage cable, single-phase AC signal cable, multi-phase AC signal cable, wood beam, metal beam, plastic pipe, water-filled plastic pipe, for example fresh water pipe, non-water filled plastic pipe, for example waste water pipe, and/or wherein the wall type classes of the wall type of the wall comprise: concrete wall, plasterboard/drywall wall, brick wall and/or bricks of the wall, floor heating, wall heating.

This may achieve the technical advantage that objects and walls of different types may be detected and classified.

In one aspect, there a method for training an artificial intelligence of a wall diagnostic measuring device is provided, comprising:
providing a training dataset for training an artificial intelligence, wherein the training dataset comprises a wall and a radar data depicting an object embodied in the wall as well as the feedback information provided according to the method of operating a measuring device;
training the artificial intelligence based on the training dataset and taking into account the feedback information to perform object recognition of an object formed in a wall, wherein the object recognition comprises at least one object detection and an object classification.

In this way, the technical advantage can be achieved that improved training of the artificial intelligence of the wall diagnostic device, in particular post-training, is enabled, in which feedback is taken into account by the user of the wall diagnostic devices.

Provided according to one aspect is a computing unit configured to perform the method of operating a measuring device according to one of the preceding embodiments and/or the method of training an artificial intelligence.

According to one aspect, a computer program product is provided, comprising instructions that, when the program is executed by a data processing unit, cause the data processing unit to perform the method for operating a measuring device according to one embodiment and/or the method for training an artificial intelligence.

### BRIEF DESCRIPTION OF THE DRAWINGS

Embodiments of the disclosure are described with reference to the following figures. The figures show:

FIG. 1 a schematic illustration of a measuring device according to one embodiment;

FIG. 2 a further schematic illustration of the measuring device according to a further embodiment;

FIG. 3 a further schematic illustration of the measuring device according to a further embodiment;

FIG. 4 a schematic illustration of a measurement of the measuring device according to one embodiment,

FIG. 5 a further schematic illustration of the measuring device according to a further embodiment;

FIG. 6 a schematic illustration of a system for operating a measuring device according to one embodiment,

FIG. 7 a flowchart of a method for operating a measuring device according to one embodiment of the disclosure,

FIG. 8 a further flowchart of the method for operating a measuring device according to a further embodiment,

FIG. 9 a flowchart of a method for training an artificial intelligence of a measuring device according to one embodiment, and

FIG. 10 a schematic representation of a computer program product.

### DETAILED DESCRIPTION

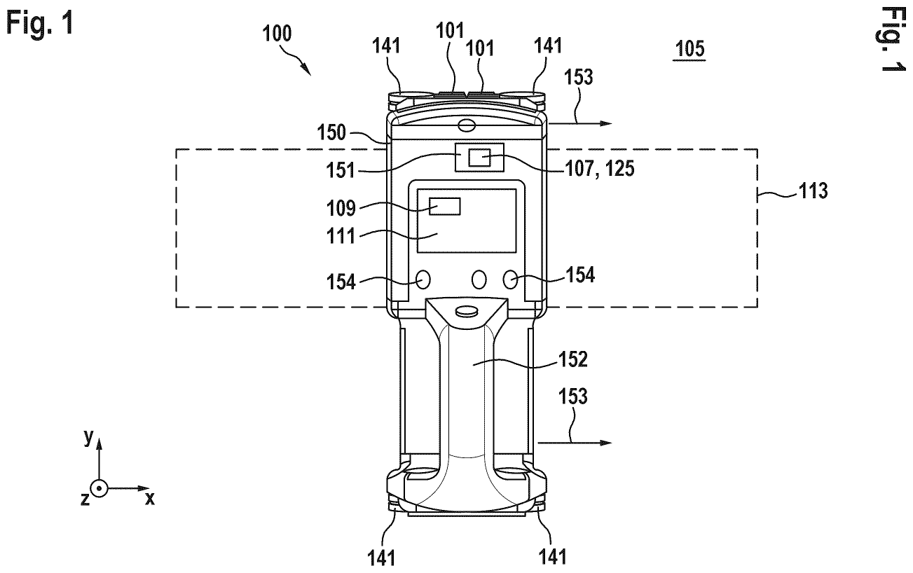

FIG. 1 shows a schematic representation of a measuring device 100 according to one embodiment.

The present disclosure relates to a measuring device, in particular to a wall diagnostic device for examining walls 105 to be processed. Wall diagnostic devices are known in the prior art that are used to detect objects disposed in walls. Such devices allow the user to examine walls to be processed to search for objects disposed in the walls in order to be able to perform planned work, for example drilling in walls, based on this such that damage to the objects disposed in the walls can be avoided.

In the embodiment shown, the measuring device 100 comprises a housing 150 having a handle 152 for grasping of the measuring device 100 by the user, the display unit 111 for displaying diagnostic results 109 of the wall diagnostics, and controls 154 for switching the measuring device 100 to various operating modes.

According to the disclosure, the measuring device 100 comprises at least one radar sensor unit 101. By way of the radar sensor unit 101, radar signals may be transmitted towards the wall 105 to be examined and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform a corresponding diagnosis of the wall to be examined based on the radar data 103 of the radar sensor unit 101. The radar data 103 of the radar sensor unit 101 thereby depicts the wall 105 to be examined and, if applicable, objects 113 disposed within the wall 105.

The wall diagnostics carried out by the diagnostic module 107 comprises at least performing an object recognition. The object recognition here comprises an object detection and an object classification of the object 113 disposed in the wall 105. The object detection comprises at least the determination of an object position 115. The object position here describes the positioning of the object disposed in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 disposed in the wall 105, are subsequently presented in a display unit 111 of the measuring device 100 to the user of the measuring device 100. For example, the display unit 111 may be configured as a corresponding display and the diagnostic results 109 may be visually displayed. Additionally, the display of the diagnostic results 109 may be supported via audible and/or haptic signals. For example, the haptic signals may be realized via corresponding vibration signals.

The object 113 can be shown in the display, for example, by way of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105 and radar signals reflected from the wall 105 or the objects 113 disposed there are received via the radar sensor unit 101. This radar data 103 of the radar sensor unit 101 is used by the diagnostic module 107 to perform the wall diagnostics described above and to determine corresponding diagnostic results 109.

For example, diagnostic results 109 may comprise the object position 115 and/or object type 117 of the object 113 disposed in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to the user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than that given by the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-described wall diagnostics based on the radar data 103 of the radar sensor unit 101 and to determine at least the object position 115 and the object type 117 of an object 113 disposed in the wall 105. The object classification or determination the object type 117, respectively, comprises assigning the detected object 113 to predefined object classes.

The object classes may comprise: metal/non-metal object, low voltage cable, single-phase AC signal cable, multi-phase AC signal cable, wood beam, metal beam, plastic pipe, water-filled plastic pipe, for example fresh water pipe, non-water filled plastic pipe, for example waste water pipe, or other elements commonly installed in building walls.

Further, the artificial intelligence 125 may be trained to determine the wall type 123 of the wall 105 to be examined at least based on the radar data 103 of the radar sensor unit 101. Possible wall types 123 may comprise: concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by way of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can in particular be used for object recognition of the objects 113 disposed in the walls 105. The additional sensor information may possibly provide improved detection of the objects 113 and may possibly provide improved classification of the objects 113.

In particular, for example, the material of the objects 113, for example as a metallic or non-metallic material, can be improved and classified by using the additional sensor information.

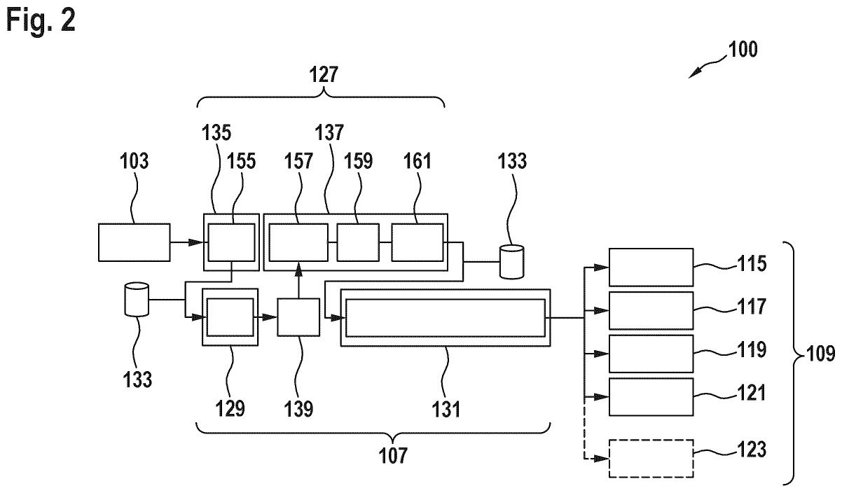

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing of the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall to be examined 105 and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be included in the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. In the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects on the radar data 103 can occur.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs the object recognition of the object 113 disposed in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed radar echoes of different frequencies may be used as radar data 103 and as input data for the diagnostic module 107. Alternatively, radar data 103 processed via multiple steps may be used. The pre-processing steps comprise, for example, the transformation of the signals from the frequency domain to the time or distance domain, background deduction, noise removal, and normalization of the signals. For radar data 103 which is available in the form of complex numbers, only the absolute value can be processed. Alternatively or additionally, the phase information may be considered.

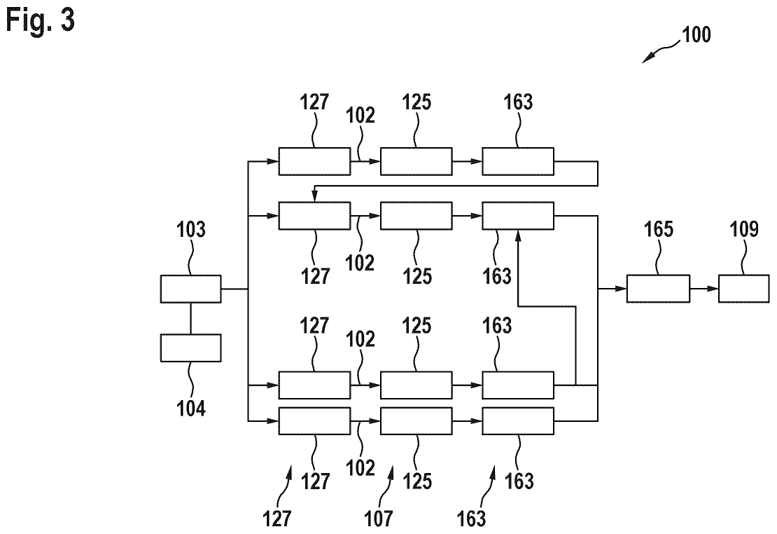

FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, for example, comprising the wall type classification module 129 and/or the object recognition module 131 according to the embodiment in FIG. 2, and a post-processing module 163.

In FIG. 3, primarily the radar data 103 is shown as input data for the wall diagnostics. In addition to the radar data shown, however, the additional information of the additional sensors may also serve as input data for the wall diagnostics. Here, the different information from the different types of sensors in the different parallel processing paths 102 can be processed and the corresponding wall diagnostics performed separately on the different sensor information. Upon completion of the wall diagnostics, a summary module may be used to assemble a summary of the individual sub-analysis results to form the diagnostic results 109 of the wall diagnostics.

Alternatively or additionally, different sub-aspects of the wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moved relative to the wall 105, may then be processed in the different processing paths 102 by the modules shown.

The different processing paths perform a stand-alone wall diagnostics in this respect, comprising at least determining the object position 115 and/or the object type 117 of the object 113 disposed in the wall 105.

The summary module 165 may summarize the sub-results provided in the individual processing paths 102 of the stand-alone wall diagnostics of the different regions of the wall 105 into a contiguous diagnostic result 109. The contiguous diagnostic result here describes the wall diagnostics of a contiguous spatial area that was covered during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object disposed in the wall 113 can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may respectively be carried out. In the summary module 165, the various sub-results of the wall diagnostics may be summarized into corresponding diagnostic results 109.

The diagnostic module 107 can be divided into different artificial intelligences 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligences 125, for example, neural networks. Alternatively, the various modules may form portions of an overall artificial neural network that are connected to an overall neural network according to structures known in the prior art.

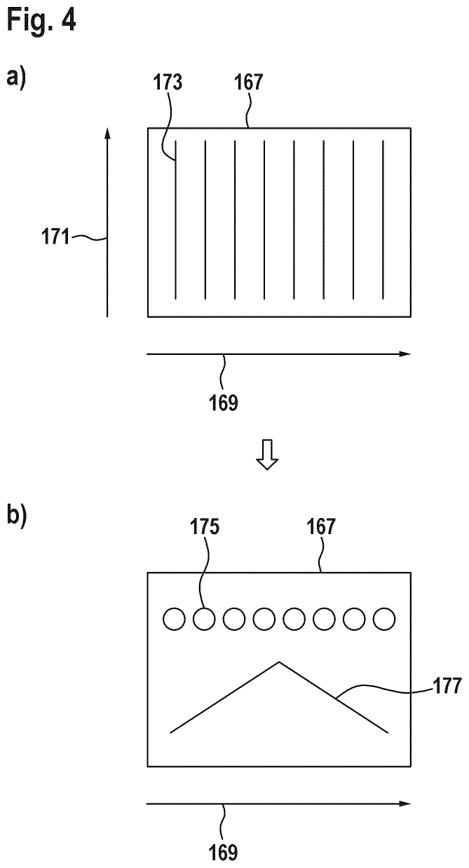

FIG. 4 shows a schematic illustration of a measurement of the measuring device 100 according to one embodiment.

For pre-processing, the radar data 103 or the additional sensor information 104 of the remaining sensors may be normalized, in particular to numerically stabilize the subsequent steps performed by the diagnostic module 107 during wall diagnostics. For example, an amplitude and/or offset compensation may be performed for this purpose. Further, to reduce interference, filtering of the radar data 103 may be carried out, and to reduce the data rate the corresponding sensor data may be sampled. Further, the radar data 103 or the additional sensor information 104 may be transformed to the respective required frequency range or time range. Methods known from the prior art can be used for this purpose.

Further, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement of the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more scan points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment of FIG. 2, the corresponding input data can comprise the respective pre-processed sensor data, i.e. radar data 103 and additional sensor information 104 of the additional sensors.

As stated above, wall diagnostics may be performed by the diagnostic module 107 based on a correspondingly trained artificial intelligence. Alternatively, different processing paths may also be calculated by rule-based algorithms. A combination of artificial intelligence and a rule-based algorithm is also possible within a processing path 102 in the form of a parallel connection or concatenation.

The diagnostic results 109 of the wall diagnostics may be implemented as numeric values, vectors, or matrices. Further, the probability of detection, or for the wall type classification and/or the object classification, respectively, a probability of the specified object classes and/or wall type classifications can be given for the object detection. The same may apply to the position and/or depth determination, for which corresponding probability values can also be given.

If, in addition to the radar data 103, the additional sensor information of the further sensor types is processed in a processing path 102, these may either be merged within the artificial intelligence 125 or combined by rule-based combinations.

In the post-processing of each processing path 102, of the embodiment of FIG. 3, multiple algorithm results based on multiple windows 167 may be summarized by the summary module 165. This summary can in particular be realized by majority formation, sum formation or also by multiplication of successive probability values.

Further, by clustering multiple results, for example, it is possible to detect which objects of multiple detected objects lying close to one another are the same object so that they are not incorrectly detected multiple times.

Likewise, it is possible to multiply a weighting function 177 when summarizing the results from multiple windows 167. Advantageously, the diagnostic sub-results 175 corresponding to corresponding data points in the space may be weighted with respect to positioning of the diagnostic sub-results 175 relative to a center point of the respective window 167. This is illustrated by way of example in graph b), in which the individual diagnostic sub-results 175 are weighted according to the weighting function 177 shown with respect to the center point of the window 167 shown.

According to one embodiment, the results of one processing path 102 after post-processing 163 may influence the extension of another processing path 102. Here, weighting parameters may be adjusted that may depend on the particular result from the processing path 102 for each window.

For example, the result of an object classification in which the object type 117 of an object disposed in the wall 105 is defined can be utilized to increase the weight of a wall type classification in which the wall type 123 of the respective wall 105 is determined in the post-processing at locations without objects 113, because the respective radar data 103 at these locations are less influenced by reflections of the objects 113.

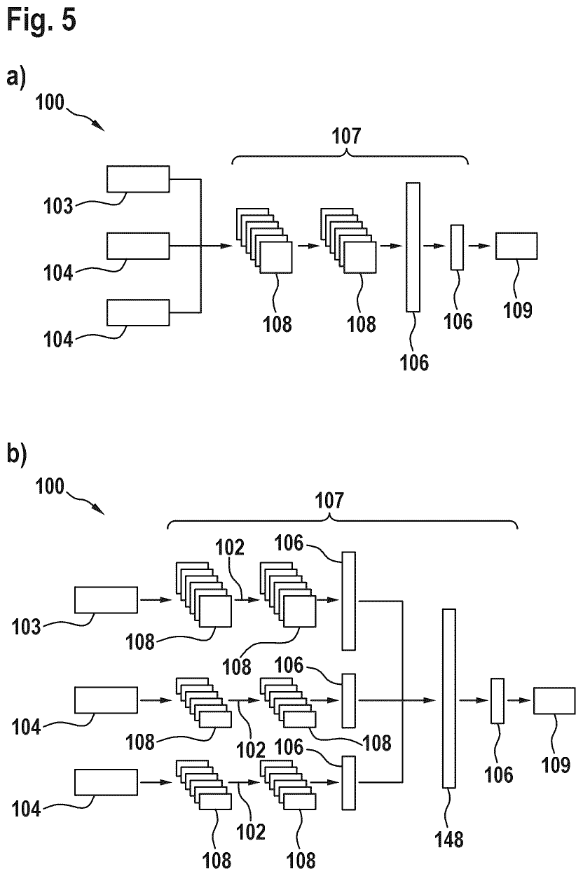

FIG. 5 shows a further schematic representation of the measuring device 100 according to a further embodiment.

Graphs a) and b) of FIG. 5 show two different alternatives of a joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107, based on this.

In graph b), in contrast, the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnoses of the different processing paths 102 are combined and fed to a final dense layer 106. The output data of the diagnostic module 107 corresponds to the diagnostic results 109 described above.

The correspondingly configured diagnostic module 107 is designed to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known in the prior art.

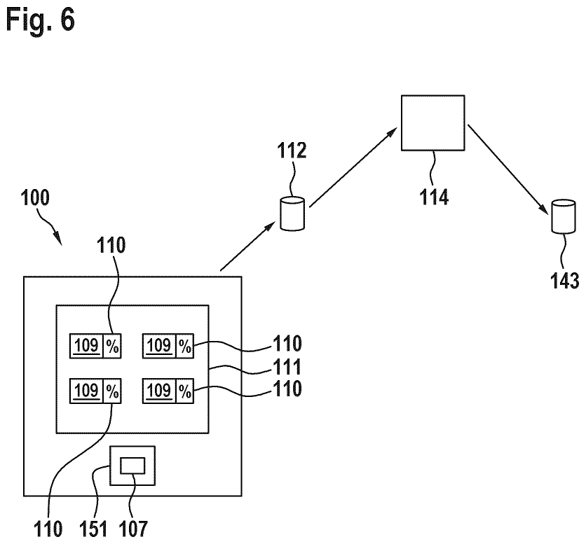

FIG. 6 shows a schematic illustration of a system 600 for operating a measuring device 100 according to one embodiment.

In the embodiment shown, the system for operating a measuring device 100 comprises an external server unit 114 in addition to the measuring device 100.

According to the disclosure, the measuring device 100 first receives the radar data 103 of the radar sensor unit 101. The radar data 103 here depicts the wall 105 to be examined, including the objects 113 disposed therein.

The wall diagnostics are performed by the diagnostic module 107 based on the radar data 103 and corresponding diagnostic results 109 are generated. The wall diagnostics comprise performing at least one of object recognition and object detection, with determination of an object position 115 and an object classification, with determination of the object type 117 of the objects 113 disposed in the wall 105.

According to the present disclosure, the wall diagnostics further comprises determining uncertainty values 110 for the diagnostic results 109. The uncertainty values here describe probability values that the determined diagnostic results 109 and an actual state of the wall 105 to be diagnosed will match. According to the disclosure, the uncertainty values 110 comprise at least probability values with respect to the determined object position 115 and probability values for the determined object type 117.

According to the present disclosure, the determined diagnostic results 109, including the uncertainty values 110, are provided by the diagnostic module 107 of the display unit 111 and are shown in the display unit 111.

In the graph shown, the diagnostic results 109 and the corresponding uncertainty values 110 are plotted graphically in the display unit 111.

The user can thus interpret the wall diagnostics or the provided diagnostic results 109 accordingly, taking into account the uncertainty values 110.

According to one embodiment, the wall diagnostics may further comprise the object depth 119 or the object extension 121 of the object 113 disposed in the wall 105, in addition to the object position 115 and the object type 117. Additionally, the wall diagnostics may comprise determining the wall type 123 of the wall 105. The object depth 119, the object extension 121 as well as the wall type 123 can be displayed as corresponding diagnostic results 109 including corresponding uncertainty values 110 in the display unit 111.

According to one embodiment, the wall diagnostics comprises determining a plurality of possible object positions 115, possible object types 117, possible object depths 119, possible object extensions 121, and/or possible wall types 123. The various possible object positions 115, object types 117, object depths 119, object extensions 121, and/or wall types 123 may be provided with corresponding uncertainty values 110 and displayed in the display unit 111.

According to one embodiment, a selection function 116 is furthermore provided to the user. By way of the selection function 116, the user can select various results of the displayed diagnostic results 109 by actuating them. For example, the user may select the correspondingly proposed wall type 123 using the selection function 116 if they know the actual wall type 123.

The correspondingly selected wall type 113 is subsequently taken into account in the remaining wall diagnostics, while the non-selected proposed wall types 123 remain unconsidered. The same applies to the additional diagnostic results 109 displayed accordingly.

According to one embodiment, feedback information 112 is provided to the external server unit 114 based on the received selection commands of the selection function 116, wherein the displayed diagnostic results 109 are selected accordingly with the selection commands by the user. The feedback information 112 comprises the selection commands and the diagnostic results 109 selected therein along with the respective radar data 103.

For example, the feedback information 112 may comprise information regarding which diagnostic results 109 the user selected as correctly representing the state of the wall 105. Further, the feedback information 112 may comprise information as to which diagnostic results 109 the users have not selected as correctly representative.

Based on the feedback information 112, the external server unit 114 may improve the diagnostic module in terms of wall diagnostic quality by training the algorithm of the diagnostic module 107.

According to one embodiment, the feedback information 112 is provided by a plurality of different measuring devices 100. The measuring devices 100 can be used, for example, by a plurality of users in normal operation. For example, during operation of the measuring device, the corresponding feedback information 109 is initially stored on a corresponding storage unit of the measuring device 100 and provided to the external server unit 114.

According to one embodiment, the external server unit 114 is further configured to generate a training dataset 143, taking the feedback information into account. Based on the training dataset 143, re-training of the diagnostic module 107 is enabled, with re-training taking the feedback information 112 into account. The correspondingly retrained diagnostic module 107 may subsequently be installed in new measuring devices 100 and/or installed in already existing measuring devices 100 as an update to the existing diagnostic module 107. By considering the feedback information in the training of diagnostic module 107, the performance of the diagnostic module 107 can be improved.

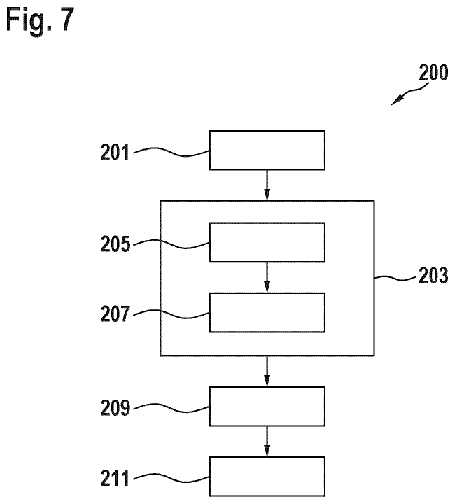

FIG. 7 shows a flowchart of a method 200 for operating a measuring device 100 according to one embodiment.

To operate the measuring device 100, in a first method step 201, radar data 103 of the radar sensor unit 101 of the measuring device 100 is first received.

In a further method step 203, the wall diagnostics are performed by the diagnostic module 107 of the measuring device 100 based on the radar data 103.

For this purpose, in a method step 205, a wall detection of the object 113 disposed in the wall 105 is performed by the diagnostic module 107. The object recognition comprises at least one object detection with determination of the object position 115 and an object classification with determination of the object type 117 of the object 113.

In a further method step 207, corresponding uncertainty values 110 are determined for the generated diagnostic results 109. The uncertainty values describe probabilities of the diagnostic results 109 being consistent with the actual state of the wall 105 being diagnosed.

In a further method step 209, the diagnostic results 109 and the uncertainty values 110 of the display unit 111 of the measuring device 100 are provided. In a further method step 211, the diagnostic results 109 and the uncertainty values 110 are displayed in the display unit 111.

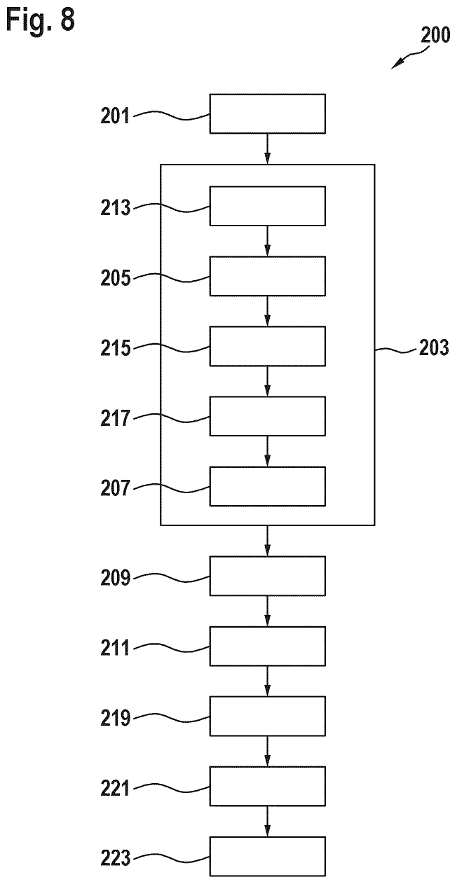

FIG. 8 shows a further flowchart of the method 200 for operating a measuring device 100 according to a further embodiment.

The embodiment in FIG. 8 is based on the embodiment in FIG. 7 and comprises all the method steps described there.

In the embodiment shown, the wall diagnostics further comprises performing a wall type classification and determining a wall type 123 in a method step 213. Further, in a method step 215, an object depth determination is performed and an object depth 119 of the object 113 is determined.

Further, in a method step 217, an object extension determination is performed and the object extension 121 of the object 113 is determined.

Moreover, in a method step 219, the selection function 116 is provided.

In a method step 221, the selection commands of the selection function 216 are received, wherein one of the displayed diagnostic results is selected by the selection commands.

In another method step 223, feedback information 112 is provided to an external server unit 114. The feedback information 112 comprises the selection commands and the diagnostic results 109 selected therein, including the respective radar data 103.

According to one embodiment, the wall diagnostics may also be performed in consideration of additional sensor information 104.

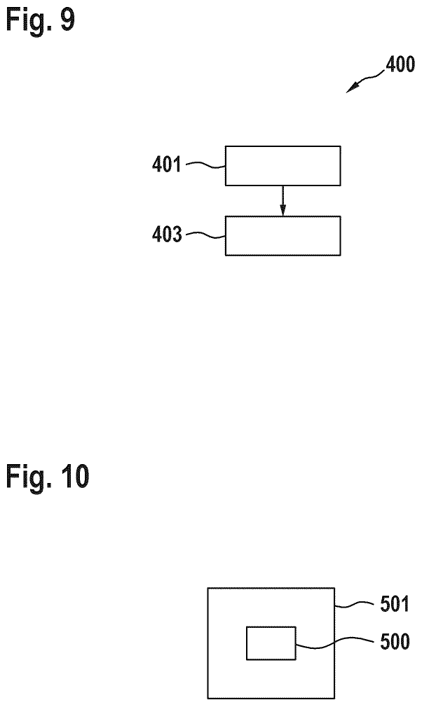

FIG. 9 shows a flowchart of a method 400 for generating a training dataset for training an artificial intelligence 125 of a measuring device 100 according to one embodiment.

To train the artificial intelligence 125 of the measurement device 100 for wall diagnostics, in one a method step 401 a training dataset 143 is first provided for training the artificial intelligence 125. The training dataset 143 comprises radar data 103 that depicts the walls 105 to be diagnosed, including the objects 113 formed in the walls 105. Further, the training dataset 123 comprises the feedback information 112 provided according to the method 200 described above for operating the measuring device 100. The feedback information 112 is included in the training dataset 143 as additional information in addition to the provided radar data 103.

The radar data 103 can be based on measurements performed solely to create a training dataset. Alternatively or additionally, the radar data 103 may have been incorporated by a plurality of users during operation of a plurality of measuring devices 100 and provided to create the training dataset 143 of the external server unit 116.

In another method step 403, the artificial intelligence training is performed based on the previously generated provided training dataset 143, taking the feedback information into account. The artificial intelligence 125 is trained to perform object recognition of objects 113 formed in walls 105.

FIG. 10 shows a schematic representation of a computer program product 500 comprising instructions that, when the program is executed by a data processing unit, cause the latter to perform the method 200 for operating a measuring device 100 and/or the method 400 for training an artificial intelligence 125.

In the embodiment shown, the computer program product 500 is stored on a storage medium 501. The storage medium 501 can in this case be any desired storage medium known from the prior art.

What is claimed is:

1. A method of operating a measuring device, comprising:
receiving radar data of a radar sensor unit of the measuring device, wherein the radar data depicts a wall to be diagnosed;
performing wall diagnostics by performing an analysis of the radar data and providing diagnostic results with a diagnostic module of the measuring device, wherein the performing wall diagnostics comprises:
performing an object recognition of an object disposed in the wall using the diagnostic module, wherein the object recognition comprises an object detection and an object classification, and wherein the diagnostic results comprise at least one object position in the wall and/or an object type of the object; and
determining uncertainty values of the diagnostic results using the diagnostic module, wherein the uncertainty values of the diagnostic results describe the probability values that the diagnostic results match an actual state of the wall to be diagnosed, and comprise at least one probability value of the object position and/or one probability value of the object type of the object;
providing the diagnostic results and the uncertainty values by the diagnostic module to a display unit of the measuring device; and
displaying the diagnostic results and the uncertainty values in the display unit.

2. The method according to claim 1, wherein the wall diagnostics further comprises:
performing wall type classification and determining a wall type of the wall using the diagnostic module; and/or
performing an object depth determination and determining an object depth of the object in the wall using the diagnostic module, wherein the object depth is defined as a distance of the object to a surface of the wall; and/or
performing an object extension determination and determining an object extension of the object along a predefined direction using the diagnostic module, wherein the uncertainty values further comprise at least one probability value of the wall type and/or a probability value of the object depth and/or a probability value of the object extension of the object.

3. The method according to claim 1, wherein a plurality of possible object positions and/or a plurality of possible object types of the object are determined in the object recognition as stand-alone diagnostic results, and/or wherein a plurality of possible wall types of the wall are determined as stand-alone diagnostic results in the wall type classification, and/or wherein a plurality of possible object depths are determined as stand-alone diagnostic results in the object depth determination and/or wherein a plurality of possible object extensions of the object are determined in the object extension determination as stand-alone diagnostic results, wherein each of the plurality of diagnostic results is provided with a probability value, and wherein the plurality of diagnostic results and the plurality of probability values are displayed in the display unit.

4. The method according to claim 3, further comprising:
providing a selection function, wherein when a user of the measuring device executes the selection function, at least one of the displayed diagnostic results is selectable.

5. The method according to claim 4, further comprising:
receiving selection commands of the selection function, wherein one of the displayed diagnostic results is selected by the user using the selection commands; and
providing feedback information to an external server unit, wherein the feedback information comprises the selection commands and the diagnostic results selected there along with the respective radar data.

6. The method according to claim 1, wherein the measuring device further comprises at least one of an induction sensor and/or an eddy current sensor and/or a capacitance sensor and/or an AC current sensor and/or an NMR sensor and/or an ultrasonic sensor for providing additional sensor data, and wherein the diagnostic module is configured to perform the wall diagnosis by taking into account the additional sensor data.

7. The method according to claim 1, wherein the diagnostic module comprises at least one correspondingly trained artificial intelligence configured to perform object recognition and/or a wall classification and/or an object depth determination based on the radar data and/or the additional sensor data.

8. The method according to claim 1, wherein object classes of the object type of the object comprise: metal/non-metal object, low voltage cable, single-phase AC signal cable, multi-phase AC signal cable, wood beam, metal beam, plastic pipe, water-filled plastic pipe, non-water filled plastic pipe, and/or wherein the wall type classes of the wall type of the wall comprise: concrete wall, plasterboard/drywall wall, brick wall and/or bricks of the wall, floor heating, wall heating.

9. A method for training an artificial intelligence of a measuring device used for wall diagnostics, comprising:
providing a training dataset for training the artificial intelligence, wherein the training dataset comprises a wall and radar data depicting an object formed in the wall, as well as the feedback information provided according to claim 5; and
training the artificial intelligence based on the training dataset and taking into account the feedback information for performing object recognition of an object formed in a wall, wherein the object recognition comprises at least one of object detection and object classification.

10. A computing unit configured to perform the method for operating a measuring device according to claim 1.

11. A computer program product comprising instructions that, when the program is executed by a data processing unit, cause the latter to perform the method for operating a measuring device according to claim 1.

12. The method according to claim 1, wherein the measuring device is a wall diagnostic device.

13. The method according to claim 8, wherein:
the water-filled plastic pipe is a fresh water pipe, and
the non-water filled plastic pipe is a waste water pipe.

14. A computing unit configured to perform the method for training an artificial intelligence of a measuring device to perform wall diagnostics according to claim 9.

15. A computer program product comprising instructions that, when the program is executed by a data processing unit, cause the latter to perform the method for training an artificial intelligence of a measuring device to perform wall diagnostics according to claim 9.
